(19) United States
(12) Patent Application Publication
(10) Pub. No.: US 2014/0198844 A1
(43) Pub. Date: Jul. 17, 2014

(54) METHOD AND APPARATUS FOR NON-CROSS-TILE LOOP FILTERING

(71) Applicant: MEDIATEK INC., Hsin-Chu (TW)

(72) Inventors: Chih-Wei Hsu, Taipei (TW); Chia-Yang Tsai, New Taipei (TW); Yu-Wen Huang, Taipei (TW)

(21) Appl. No.: 14/239,349

(22) PCT Filed: Oct. 19, 2012
(86) PCT No.: PCT/CN2012/083212

§ 371 Date: Feb. 18, 2014

Related U.S. Application Data
(60) Provisional application No. 61/550,636, filed on Oct. 24, 2011.
(60) Provisional application No. 61/554,601, filed on Nov. 2, 2011.
(60) Provisional application No. 61/558,664, filed on Nov. 11, 2011.

(51) Int. Cl. H04N 19/117; H04N 19/154

(52) U.S. Cl. CPC H04N 19/00066; H04N 19/002
USPC 375/240.07

(57) ABSTRACT

A method and apparatus for loop filter processing of video data are disclosed. Embodiments according to the present invention eliminate data dependency associated with loop processing across tile boundaries. According to one embodiment, loop processing is reconfigured to eliminate data dependency across tile boundaries if cross-tile loop processing is disabled. The loop filter processing corresponds to DF (deblocking filter), SAO (Sample Adaptive Offset) processing or ALF (Adaptive Loop Filter) processing. The processing can be skipped for at least one tile boundary. In another embodiment, data padding based on the pixels of the current tile or modifying pixel classification footprint are used to eliminate data dependency across the tile boundary. Whether cross-tile loop processing is disabled can be indicated by a flag coded at sequence, picture, or slice level to indicate whether the data dependency across said at least one tile boundary is allowed.

### CROSS REFERENCE TO RELATED APPLICATIONS

The present invention claims priority U.S. Provisional Patent Application No. 61/550,636, filed on Oct. 24, 2011, entitled “Non-Cross-Tiles Loop Filtering”, U.S. Provisional Patent Application No. 61/554,601, filed on Nov. 2, 2011, entitled “Non-Cross-Tiles Loop Filtering and Syntax Design”, and U.S. Provisional Patent Application No. 61/558,664, filed on Nov. 11, 2011, entitled “Tile Information Adaptation”. These U.S. Provisional Patent Applications are hereby incorporated by reference in their entireties.

### TECHNICAL FIELD

The present invention relates to video coding. In particular, the present invention relates to video coding techniques associated with filtering and processing at tile boundaries.

### BACKGROUND

Motion estimation is an effective inter-frame coding technique to exploit temporal redundancy in video sequences. Motion-compensated inter-frame coding has been widely used in various international video coding standards. The motion estimation adopted in various coding standards is often a block-based technique, where motion information such as coding mode and motion vector is determined for each macroblock or similar block configuration. In addition, intra-coding is also adaptively applied, where the picture is processed without reference to any other picture. The inter-predicted or intra-predicted residues are usually further processed by transformation, quantization, and entropy coding to generate a compressed video bitstream. During the encoding process, coding artifacts are introduced, particularly in the quantization process. In order to alleviate the coding artifacts, additional processing can be applied to reconstructed video to enhance picture quality in newer coding systems. The additional processing is often configured in an in-loop operation so that the encoder and decoder may derive the same reference pictures to achieve improved system performance.

FIG. 1 illustrates an exemplary adaptive inter/intra video coding system incorporating in-loop filtering process. For inter-prediction, Motion Estimation (ME)/Motion Compensation (MC) 112 is used to provide prediction data based on video data from other picture or pictures. Switch 114 selects Intra Prediction 110 or inter-prediction data from ME/MC 112 and the selected prediction data is supplied to Adder 116 to form prediction errors, also called prediction residues or residues. The prediction error is then processed by Transformation (T) 118 followed by Quantization (Q) 120. The transformed and quantized residues are then coded by Entropy Encoder 122 to form a video bitstream corresponding to the compressed video data. The bitstream associated with the transform coefficients is then packed with side information such as motion, mode, and other information associated with the image unit. The side information may also be processed by entropy coding to reduce required bandwidth. Accordingly, the side information data is also provided to Entropy Encoder 122 as shown in FIG. 1 (the motion/mode paths to Entropy Encoder 122 are not shown). When the inter-prediction mode is used, a previously reconstructed reference picture or pictures have to be used to form prediction residues. Therefore, a reconstruction loop is used to generate reconstructed pictures at the encoder end. Consequently, the transformed and quantized residues are processed by Inverse Quantization (IQ) 124 and Inverse Transformation (IT) 126 to recover the processed residues. The processed residues are then added back to prediction data 136 by Reconstruction (REC) 128 to reconstruct the video data. The reconstructed video data may be stored in Reference Picture Buffer 134 and used for prediction of other frames.

As shown in FIG. 1, incoming video data undergoes a series of processing in the encoding system. The reconstructed video data from REC 128 may be subject to various impairments due to the series of processing. Accordingly, various loop processing is applied to the reconstructed video data before the reconstructed video data is used as prediction data in order to improve video quality. In the High Efficiency Video Coding (HEVC) standard being developed, Deblocking Filter (DF) 130, Sample Adaptive Offset (SAO) 131 and Adaptive Loop Filter (ALF) 132 have been developed to enhance picture quality. The Deblocking Filter (DF) 130 is applied to boundary pixels and the DF processing is dependent on the underlying pixel data and coding information associated with corresponding blocks. There is no DF-specific side information needs to be incorporated in the video bitstream. On the other hand, the SAO and ALF processing are adaptive, where filter information such as filter parameters and filter type may be dynamically changed according to the underlying video data. Therefore, filter information associated with SAO and ALF is incorporated in the video bitstream so that a decoder can properly recover the required information. Therefore, filter information from SAO and ALF is provided to Entropy Encoder 122 for incorporation into the bitstream. In FIG. 1, DF 130 is applied to the reconstructed video first; SAO 131 is then applied to DF-processed video; and ALF 132 is applied to SAO-processed video. However, the processing order among DF, SAO and ALF may be re-arranged. In H.264/AVC video standard, the adaptive filters only include DF. In the High Efficiency Video Coding (HEVC) video standard being developed, the loop filtering process includes DF, SAO and ALF. In this disclosure, in-loop filter refers to loop filter processing that operates on underlying video data without the need of side information incorporated in video bitstream. On the other hand, adaptive filter refers to loop filter processing that operates on underlying video data adaptively using side information incorporated in video bitstream. For example, deblocking is considered as an in-loop filter while SAO and ALF are considered as adaptive filters. Both in-loop filter and adaptive filter are also referred as loop filters in this disclosure.

The coding process in HEVC is applied according to Largest Coding Unit (LCU). The LCU is adaptively partitioned into coding units using quadtree. In each leaf CU, DF is performed for each 8×8 block and in HEVC Test Model Version 4.0 (HM-4.0), the DF is applies to 8×8 block boundaries. For each 8×8 block, horizontal filtering across vertical block boundaries is first applied, and then vertical filtering across horizontal block boundaries is applied. FIG. 2A illustrates an example of a vertical block boundary 210 with 4 boundary pixels on each side of the block boundary. The boundary pixels are designated as q₀, q₁, q₂ and q₃, and p₀, p₁, p₂ and p₃, where q₀ and p₀ are two pixels immediately adjacent to the vertical boundary. FIG. 2B illustrates an example of a horizontal block boundary 220 with 4 boundary pixels on each side of the block boundary. Again, the boundary pixels are designated as q₀, q₁, q₂ and q₃, and p₀, p₁, p₂ and p₃, where q₀ and p₀ are two pixels immediately adjacent to the horizontal boundary. For each picture, boundary pixel rows across one or more vertical boundaries can be horizontally filtered in parallel to improve processing speed. After horizontal filtering across vertical boundaries, boundaries pixel columns across one or more horizontal boundaries can be vertically filtered in parallel. For DF processing of the luma component, four pixels of each side (i.e., p₀ to p₃ or q₀ to q₃) are involved in filter parameter derivation. However, only three pixels on each side (i.e., p₀ to p₂ or q₀ to q₂) may be changed after DF processing. For horizontal DF of the luma component, pre-DF pixels (i.e. pixels before horizontal DF) are used for deriving filter parameters and also used as input data for DF filtering. For vertical DF of the luma component, pre-DF pixels are used for deriving filter parameters, and H-DF pixels (i.e. pixels after horizontal DF) are used as input data for DF filtering. For DF processing of chroma block boundaries, two pixels on each side, i.e., (p₀, p₁) or (q₀, q₁), are involved in filter parameter derivation, and at most one pixel on each side i.e., p₀ or q₀, may be altered after DF filtering. For horizontal filtering across vertical block boundaries, reconstructed pixels (i.e., pre-DF pixels) are used for filter parameter derivation and are used as source pixels for filtering. For vertical filtering across horizontal block boundaries, horizontal DF processed pixels (i.e. pixels after horizontal filtering) are used for filter parameter derivation and also used as input pixels for DF filtering.

Sample Adaptive Offset (SAO) 131 is also adopted in HM-4.0, as shown in FIG. 1. SAO is regarded as a special case of filtering where the processing only applies to one pixel. SAO can divide one picture into multiple LCU-aligned regions, and each region can select one SAO type among two Band Offset (BO) types, four Edge Offset (EO) types, and no processing (OFF). For each to-be-processed (also called to-be-filtered) pixel, BO uses the pixel intensity to classify the pixel into a band. The pixel intensity range is equally divided into 32 bands, as shown in FIG. 3. After pixel classification, one offset is derived for all pixels of each band, and the offsets of center 16 bands or outer 16 bands are selected and coded. In EO, pixel classification is first done to classify pixels into different groups (also called categories or classes). The pixel classification for each pixel is based on a 3×3 window, as shown in FIG. 4 where four configurations corresponding to 0°, 90°, 135°, and 45° are used for classification. Upon classification of all pixels in a picture or a region, one offset is derived and transmitted for each group of pixels. In HM-4.0, SAO is applied to luma and chroma components, and each of the luma components is independently processed. Similar to BO, one offset is derived for all pixels of each category except for category 0, where Category 0 is forced to use zero offset. Table 1 below lists the EO pixel classification, where “C” denotes the pixel to be classified.

TABLE 1

| Category | Condition |
|---|---|
| 1 | C < two neighbors |
| 2 | C < one neighbor && C == one neighbor |
| 3 | C > one neighbor && C == one neighbor |
| 4 | C > two neighbors |
| 0 | None of the above |

Adaptive Loop Filtering (ALF) 132 is another in-loop filtering in HM-4.0 to enhance picture quality, as shown in FIG. 1. Multiple types of luma filter footprints and chroma filter footprints are used. For example, an 11×5 cross shaped filter is shown in FIG. 5A and a 5×5 snow-flake shaped filter is shown in FIG. 5B. Each picture can select one filter shape for the luma signal and one filter shape for the chroma signal. The ALF operation is applied in the horizontal direction first. After horizontal ALF is performed, ALF is applied in the vertical direction. In HM-4.0, up to sixteen luma ALF filters and at most one chroma ALF filter can be used for each picture. In order to allow localization of ALF, there are two modes for luma pixels to select filters. One is a Region-based Adaptation (RA) mode, and the other is a Block-based Adaptation (BA) mode. In addition to the RA and BA for adaptation mode selection at picture level, Coding Units (CUs) larger than a threshold can be further controlled by filter usage flags to enable or disable ALF operations locally. As for the chroma components, since they are relatively flat, no local adaptation is used in HM-4.0, and the two chroma components of a picture share the same filter.

The RA mode simply divides one luma picture into sixteen regions. Once the picture size is known, the sixteen regions are determined and fixed. The regions can be merged, and one filter is used for each region after merging. Therefore, up to sixteen filters per picture are transmitted for the RA mode. On the other hand, the BA mode uses edge activity and direction as properties for each 4×4 block. Calculating properties of a 4×4 block may require neighboring pixels. For example, a 5×5 window 610 is used for an associated 4×4 window 620 in HM-4.0 as shown in FIG. 6. After properties of 4×4 blocks are calculated, the blocks are classified into fifteen categories. The categories can be merged, and one filter is used for each category after merging. Therefore, up to fifteen filters are transmitted for the BA mode. For the chroma components, no local adaptation is used since the chroma components are relatively smooth. The two chroma components of a picture share the same ALF filter information.

In HEVC Test Model Version 4.1 (HM-4.1), a new image unit structure, named tile, is introduced. FIG. 6 shows an example of partitioning a picture into multiple tiles, where the unit of partition is a Largest Coding Unit (LCU). The tile boundaries are indicated by the thick lines 710, 712, 720 and 722. Accordingly, the picture of FIG. 7 is divided into nine tiles, labeled from A through I. Within each tile, the processing sequence of the LCUs is according to the raster scan order as shown by the associated numbers associated with the LCUs. Within each picture, the processing sequence of the tiles is also according to the raster scan order. In other words, the processing sequence for the tiles is from tile A through tile I. Tile boundaries are aligned with LCU boundaries. Slices and tiles are configured independently. Therefore, one slice may run across multiple tiles, and one tile may also run across multiple slices.

There are two types of tiles: independent tiles and dependent tiles. Independent tiles are mainly designed for parallel processing. Reconstructing LCUs (e.g. MV prediction, intra prediction, entropy coding) and DF within one tile does not need any data from other tiles. However, in the existing HEVC system under development, SAO and ALF for one tile still need data from neighboring tiles. Consequently, parallel processing is hindered due to data dependency of SAO and ALF at the tile level. The SAO and ALF parameters are signaled in Adaptation Parameter Set (APS). In addition to SAO and ALF, other non-DF in-loop filter tools may also incorporate associated parameters in APS.

In HM-4.0, the tile parameters are coded in SPS (Sequence Parameter Set) or PPS (Picture Parameter Set). Tile parameters, num_tile_comlumn_minus1 and num_tile_row_minus1 indicate the number of tile partitions in column and row directions respectively. The number of tiles in each picture can be derived by multiplying (num_tile_comlumn_minus1+1) and (num_tile_row_minus1+1). Furthermore, a flag tile_boundary_independent_idc is used to indicate whether data dependency is allowed across tile boundaries or not. If tile_boundary_independent_idc is equal to 1, it implies independent tile processing. No data dependency is allowed across tile boundaries in this case. Otherwise, the tile is a dependent tile and data dependency is allowed across tile boundaries. Furthermore, a flag, tile_info_present_flag, is incorporated in PPS to indicate whether tile parameters are presented in PPS or in SPS. For example, if two sets of tile parameters are incorporated in SPS and PPS, the flag tile_info_present_flag is used to determine which one to use. For example, if tile_info_present_flag is equal to 1, it implies that the tile partition parameters in PPS are used. Otherwise, the tile parameters in SPS are used.

In order to support parallel tile processing for systems incorporating adaptive loop filters, such as SAO and ALF, it is desirable to develop adaptive loop filters that have no data dependency across tile boundaries.

### SUMMARY

A method and apparatus for loop filter processing of video data are disclosed. Embodiments according to the present invention eliminate data dependency associated with loop processing across tile boundaries. According to one embodiment of the present invention, loop processing is reconfigured to eliminate data dependency across tile boundaries if cross-tile loop processing is disabled. The loop filter processing reconfiguration corresponds to skipping the loop filter processing, replacing the pixels from the neighboring tile across the tile boundary using data padding, or modifying pixel classification or filter footprint to eliminate the data dependency across said at least one tile boundary. The loop filter processing corresponds to DF (deblocking filter), SAO (Sample Adaptive Offset) processing or ALF (Adaptive Loop Filter) processing. For DF, the processing can be skipped for at least one tile boundary. For SAO, the loop processing reconfiguring corresponds to skipping the loop filter processing for at least one tile boundary, replacing pixels from the neighboring tile across the tile boundary using data padding based on the pixels of the current tile, or modifying pixel classification footprint to eliminate the data dependency across the tile boundary. For ALF, the loop filter processing reconfiguring corresponds to skipping the loop filter processing for at least one tile boundary, replacing pixels from the neighboring tile across the tile boundary using data padding based on the pixels of the current tile, or modifying filter footprint to eliminate the data dependency across the tile boundary.

According to another embodiment of the present invention, filter information determination is modified to eliminate data dependency across tile boundaries and the loop processing is also reconfigured to eliminate data dependency across tile boundaries. The loop filter processing corresponds to DF (deblocking filter), SAO (Sample Adaptive Offset) processing or ALF (Adaptive Loop Filter) processing.

One aspect of the present invention addresses indication regarding whether to allow cross tile loop processing. In one embodiment, whether cross-tile loop processing is disabled is indicated by a flag and the flag is coded at sequence, picture, or slice level to indicate whether the data dependency across said at least one tile boundary is allowed. In the case that the picture contains only one tile, there is no need to use the flag.

### BRIEF DESCRIPTION OF DRAWINGS

FIG. 1 illustrates an exemplary video coding system using Inter/Intra prediction, where loop filter processing including Deblocking Filter (DF), Sample Adaptive Offset (SAO) and Adaptive Loop Filter (ALF) is incorporated.

FIG. 2A illustrates pixels on both sides of a vertical boundary involved in Deblocking Filter.

FIG. 2B illustrates pixels on both sides of a horizontal boundary involved in Deblocking Filter.

FIG. 3 illustrates an example of Band Offset (BO) by equally dividing the pixel intensity range into 32 bands.

FIG. 4 illustrates Edge Offset (EO) pixel classification based on a 3×3 window, with four configurations corresponding to 0°, 90°, 135°, and 45°.

FIG. 5A illustrates an 11×5 cross shaped filter for Adaptive Loop Filter (ALF).

FIG. 5B illustrates a 5×5 snow-flake shaped filter for Adaptive Loop Filter (ALF).

FIG. 6 illustrates an example of Block-based Adaptation (BA) mode Adaptive Loop Filter (ALF) using a 4×4 BA window with a 5×5 supporting window.

FIG. 7 illustrates an example tile partition where the picture is partitioned into three rows and three columns of tiles.

FIG. 8 illustrates an exemplary Sequence Parameter Set (SPS) syntax design incorporating an embodiment of the present invention.

FIG. 9 illustrates an exemplary Picture Parameter Set (PPS) syntax design incorporating an embodiment of the present invention.

FIG. 10 illustrates an exemplary flow chart of a system incorporating an embodiment of the present invention.

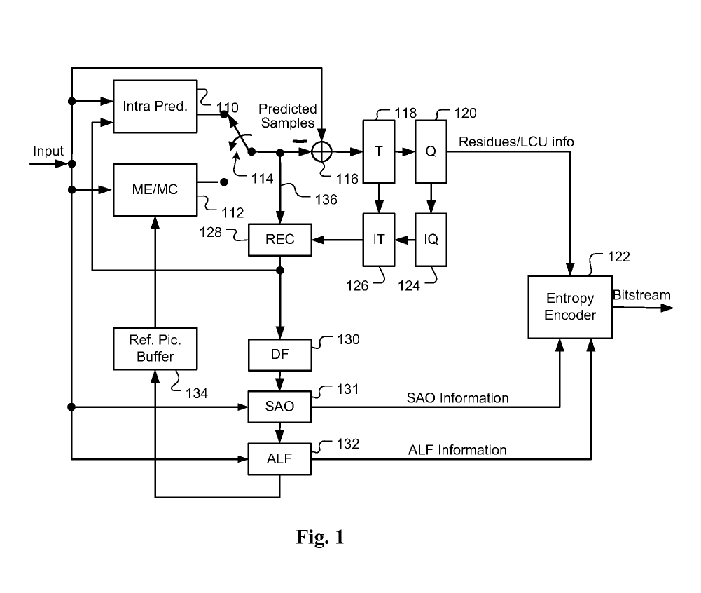

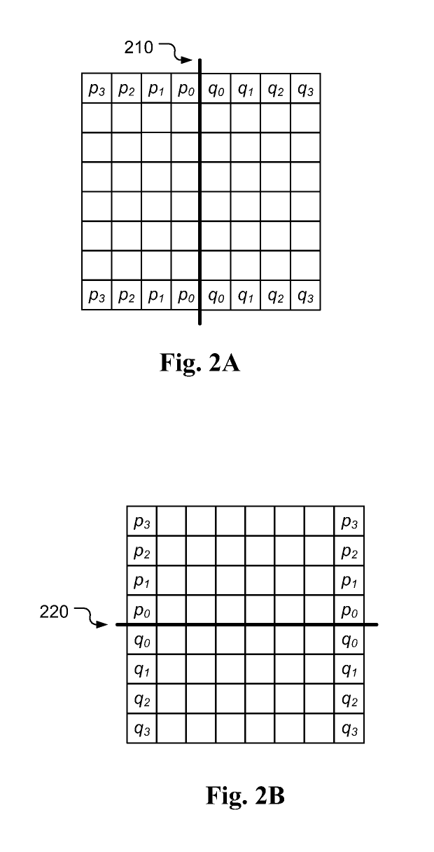

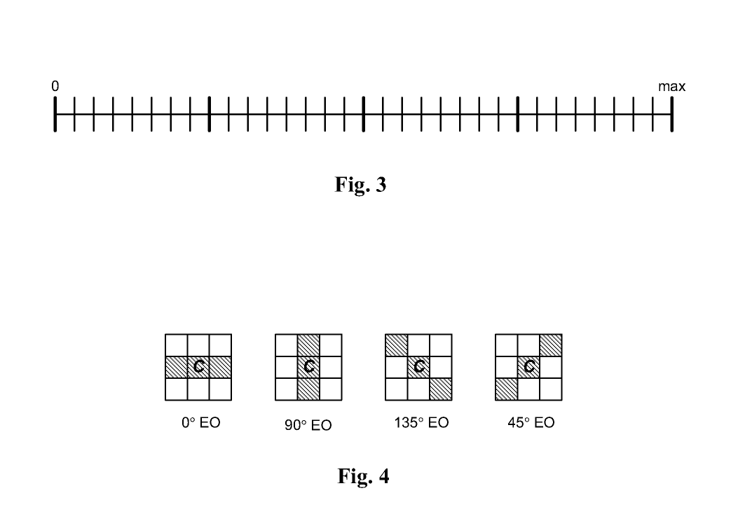

### DETAILED DESCRIPTION

In order to allow parallel tile processing for systems incorporating loop filters such as DF, SAO and ALF, embodiments according to the present invention adopt loop filters that do not rely on data from neighboring tiles. As mentioned before, the DF, SAO and ALF processes rely on neighboring data for parameter derivation and filter control. For DF, SAO and ALF, the filtering operation also relies on neighboring pixels. The present invention removes the data dependency for DF, SAO and ALF at tile boundaries to allow independent tile-based processing. The data dependency across tile boundaries can be applied to loop filter processing only. Alternatively, data dependency across tile boundaries can be applied to loop filter processing as well as filter information determination (including parameter derivation and/or filter control). Accordingly, embodiments of the present invention allow tiles in a picture to be processed in parallel.

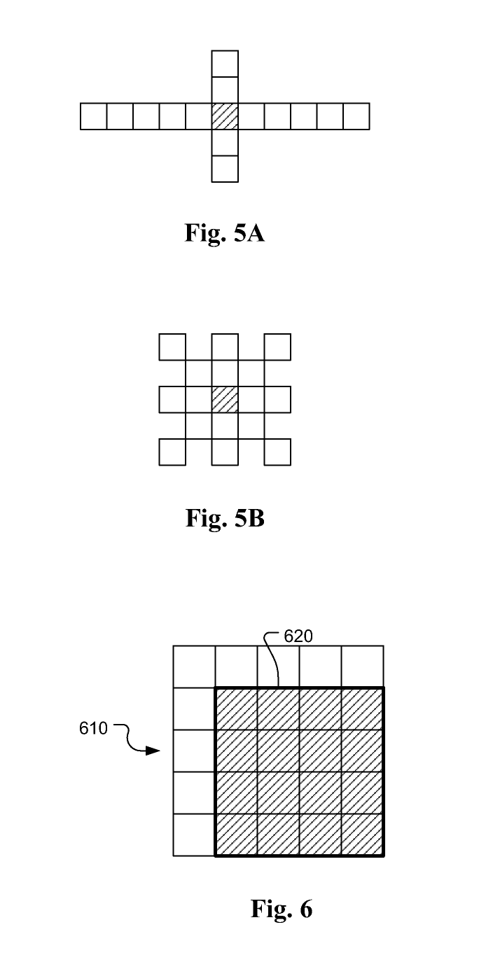

In one embodiment of the present invention, data padding is used to replace required pixels in a neighboring tile of the tile boundaries. For example, when the 5×5 snowflake filter in FIG. 5B is applied to a location immediately adjacent to a tile boundary or one pixel away from a tile boundary, the ALF operation will require some pixel data from neighboring tile. According to this embodiment, the required pixel data from the neighboring tile for ALF operation will be replaced by padding. The data padding can be achieved by data repeating (repetitive), linear extrapolation, nonlinear extrapolation or other means to generate the needed data in the neighboring tile. There are various means to achieve data repeating. For example, data repeating can be achieved by repeating the pixel of the current tile immediately adjacent to the tile boundary into the same row or the same column of the neighboring tile to generate the replacement pixels. Alternatively, mirror padding with odd symmetry or even symmetry may also be used. For mirror padding with odd symmetry, replacement pixels pₙ′, . . . , and p₁′ are generated for the neighboring tile, where p₁′ is the pixel immediately adjacent to the tile boundary. The corresponding pixels in the current tile are p₀, p₁, . . . , pₙ, where p₀ is the pixel immediately adjacent to the tile boundary. The replacement pixels generated by mirror padding with odd symmetry are according to pₙ′=pₙ, . . . , p₁′=p₁. For even symmetry, the replacement pixels pₙ′, . . . , and p₀′ are generated for the neighboring tile, where p₀′ is the pixel immediately adjacent to the tile boundary. ALF is applied in the horizontal direction first across vertical boundaries, and then ALF is applied in the vertical direction across horizontal boundaries.

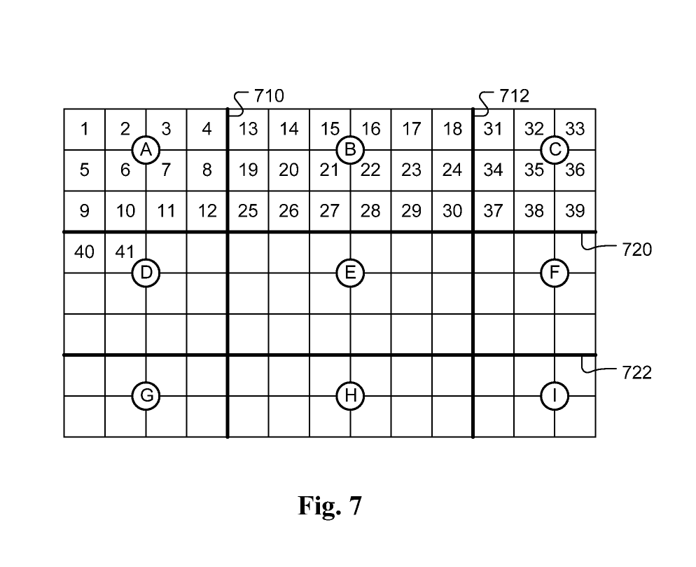

While the above loop filtering technique fully removes data dependency across tile boundaries, an embodiment of the present invention reduces data dependency instead of fully removing the data dependency. For example, an embodiment of the present invention may only remove data dependency in the vertical direction. Therefore, a tile may only have data dependency on a neighboring tile to the left or to the right of the current tile. For the tile partition shown in FIG. 7, if the vertical data dependency is removed, the row of tiles A, B and C are independent of the row of tiles D, E and F. Similarly, the row of tiles D, E and F are independent of the row of tiles G, H and I. In this case, tiles A, D and G can be processed in parallel. On the other hand, if the horizontal data dependency is removed, the tiles A, B and C can be processed in parallel. The above reducing data dependency technique can also be applied to data dependency across tile boundaries related to filter information determination.

While the above loop filtering technique removes data dependency across tile boundaries, the effectiveness of the loop filtering incorporating embodiments of the present invention may degrade slightly. Embodiments according to the present invention may apply an additional process to adjust the filtered output. For example, the filtered output may be averaged with the filter input pixel as the final ALF output pixel. A weighted sum of the filtered output and the filter input pixel may also be used as the final ALF output pixel. Accordingly, while the ALF operation does not require any pixel data from any neighboring tiles, the potential performance degradation can be lowered. The technique for generating replacement pixels by data padding can be applied to DF, SAO or any other loop filtering to remove data dependency across tile boundaries. Therefore, the tiles can be processed independently and parallel tile processing is possible. As mentioned earlier, data dependency can be removed partially to allow partial parallel processing such as parallel tile row or tile column processing.

In another embodiment of the present invention, the data dependency across tile boundaries can be achieved by skipping the loop filtering for boundary pixels where the loop filtering requires pixel data from neighboring tiles. For example, when the 5×5 snowflake filter in FIG. 5B is applied to a location immediately adjacent to or one pixel away from a tile boundary, the ALF operation will require some pixel data from neighboring tile. According to this embodiment, the ALF operation will be skipped for the locations that are immediately adjacent to the tile boundary or one pixel away from the tile boundary. Therefore, the tiles can be processed independently and parallel tile processing is possible. While ALF is used as an example to illustrate data dependency removal by skipping the filter operation for tile boundary pixels where pixel data from neighboring tile are required, the scheme can be applied to other loop filtering as well. For example, the DF process requires four neighboring luma pixels from both sides of the boundaries to determine filter control. Therefore, at tile boundaries (aligned with block boundaries), the DF operation can be skipped in order to remove data dependency. Similarly, the SAO operation can be skipped at tile boundaries to remove data dependency.

In another embodiment according to the present invention, the data footprint associated with parameter derivation/control determination or the filter footprint can be modified for boundary pixels to remove data dependency across tile boundaries. For example, the EO-based SAO performs pixel classification, as shown in FIG. 4, for an underlying pixel using the underlying pixel and two neighboring pixels. The pixel configurations (also called data footprint in this disclosure) of FIG. 4 can be modified to remove data dependency at tile boundaries. For example, when the 0° EO is applied to a pixel immediately adjacent to the left-side boundary of the tile, a pixel (to the left of the underlying pixel) in the neighboring tile will be required. According to this embodiment, the data footprint may be modified so that the 0° EO will dependent on the underlying pixel and the pixel to the right. The classification rule listed in Table 1 will be modified accordingly. Other footprints as shown in FIG. 4 can be modified similarly to remove data dependency across tile boundaries.

For BA-based ALF, the edge activity and direction are determined for each 4×4 block. Calculating the edge activity and direction of each 4×4 block is based on a 5×5 window 610 as shown in FIG. 6. One embodiment according to the present invention will modify the 5×5 window (i.e., the 5×5 data footprint) to remove data dependency across tile boundaries. Accordingly, footprint for loop filtering incorporating an embodiment of the present invention can removes data dependency.

When the filtering operation around tile boundaries involves data dependency, an alternative embodiment according to the present invention removes data dependency by modifying the filter footprint. For example, when the 11×5 cross shaped filter of FIG. 5A is applied to a location immediately adjacent to a left-side tile boundary or up to four pixels away from a left-side tile boundary, the ALF operation will require some pixel data from a neighboring tile. An embodiment according to the present invention will modify the 11×5 cross shaped filter to remove the data dependency across tile boundaries. For example, when the filter is applied to a pixel immediately adjacent to the left-side tile boundary, the filter footprint can be modified by eliminating the five pixels on the left. When the filter is applied to a location that is two pixels away from the left-side tile boundary, the filter footprint can be modified by eliminating the three pixels on the left. The filter footprint can be modified according to other boundary locations. When the filter footprint is modified, the filter coefficients need to be normalized to take into account of the modified footprint. While the 11×5 cross shaped filter is used as an example, a skilled person in the art may extend filter footprint modification to other types of filters.

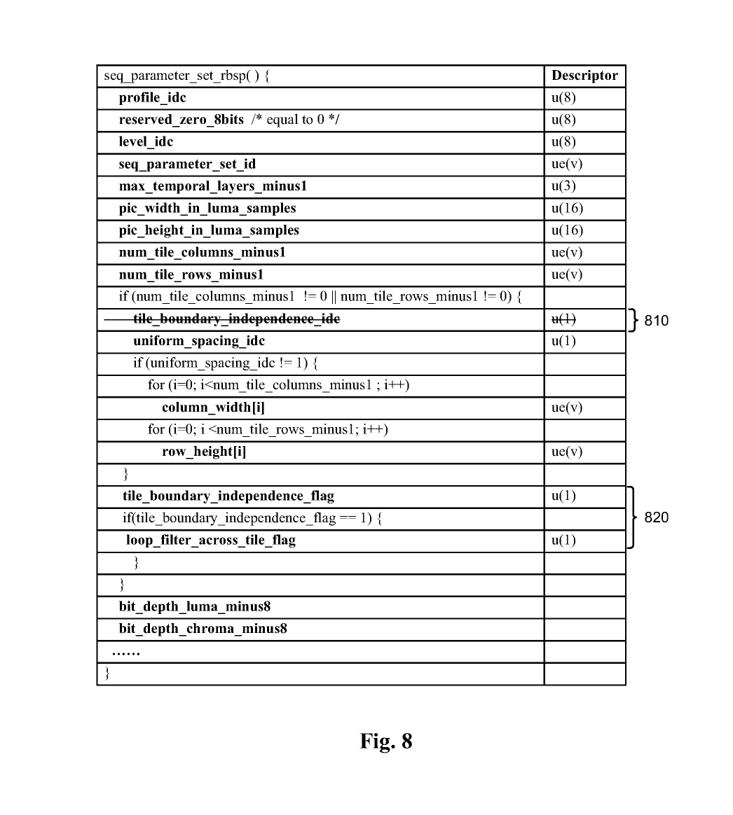

The data dependency removal mentioned above can be performed conditionally and an indication such as a flag may be used to signal whether data dependency removal is enabled or disabled. For example, a flag can be incorporated in the sequence, picture, or slice level to indicate whether the non-cross-tile loop filtering is used or not. For a picture with only one tile, there is no issue of data dependency and there is no need to use such a flag. An exemplary SPS syntax design incorporating an embodiment of the present invention is shown in FIG. 8. The changes from the syntax design based on the conventional system of HM4.0 are indicated by blocks 810 and 820. A control flag, loop_filter_across_tile_flag in both SPS and PPS is incorporated in the syntax to indicate whether the loop filtering process is cross-tile or not. If non-cross-tile loop filtering is used, i.e., loop_filter_across_tile_flag=0, the loop filtering for an underlying tile cannot use pixels from any other tile. Otherwise, the loop filtering can be applied across tile boundaries. The control flag, loop_filter_across_tile_flag is not coded if tile_boundary_independent_flag is equal to 0 which implies independent tile is not allowed. The flag, loop_filter_across_tile_flag is not coded if num_tile_columns_minus1 and num_tile_rows_minus1 (i.e., one tile column and one tile row) are both equal to 0, which implies the picture consists of only one tile. Since tile boundary dependency is indicated by new syntax elements loop_filter_across_tile_flag and tile_boundary_independent_flag, there is no need for tile_boundary_independence_idc. Accordingly, this syntax element is deleted from the conventional syntax design based on HM4.0 as indicated by block 810 of FIG. 8.

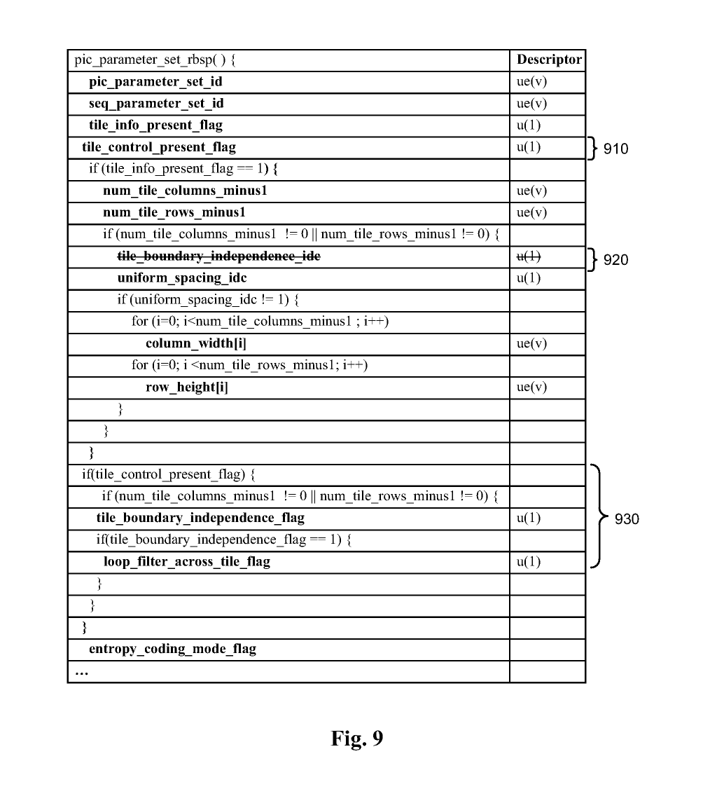

A control present flag, tile_control_present_flag is incorporated in the PPS syntax as shown in block 910 of FIG. 9 to indicate whether tile independence is signaled in the PPS. If tile_control_present_flag is equal to 0, there will be no picture-level tile independence indication as shown in block 930. The sequence level flag, loop_filter_across_tile_flag will be used at the picture level in this case. If tile_control_present_flag is equal to 1, the picture level may include its own control flag, loop_filter_across_tile_flag. However, the control flag, loop_filter_across_tile_flag is not needed if the picture has only one tile or independent tile is not allowed as indicated by tile_boundary_independent_flag=0.

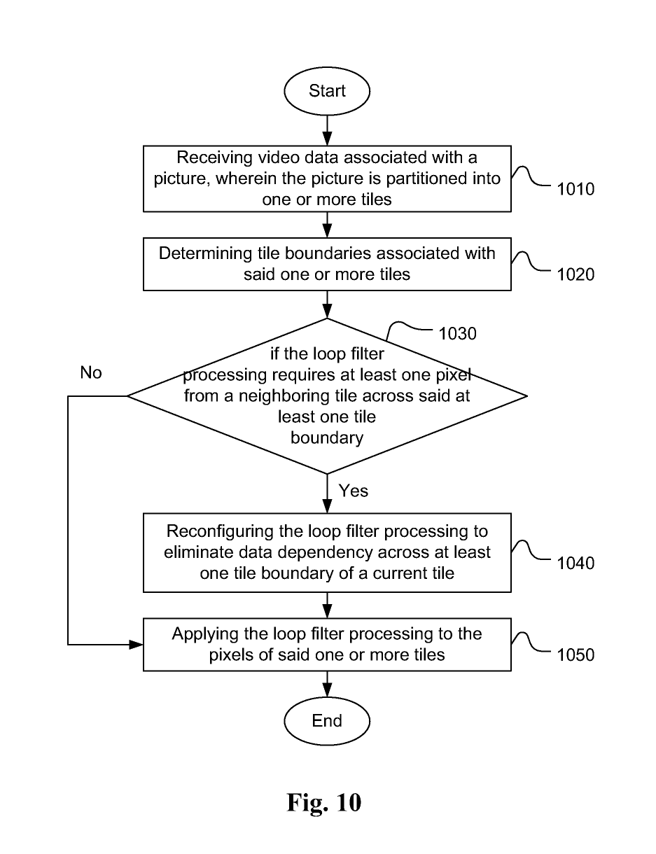

FIG. 10 illustrates an exemplary flow chart of a system incorporating an embodiment of the present invention. The video data associated with a picture is received in step 1010, where the picture is partitioned into one or more tiles. The tile boundaries associated with said one or more tiles are then determined in step 1020. Whether the loop filter processing requires at least one pixel from a neighboring tile across said at least one tile boundary is checked in step 1030. If “yes”, reconfiguring the loop filter processing to eliminate data dependency across at least one tile boundary of a current tile is performed in step 1040 and applying the loop filter processing to the pixels of said one or more tiles as shown in step 1050. If “no”, the process goes to step 1050 directly. While FIG. 10 illustrates an exemplary flow chart according to one embodiment to practice the present invention, a skilled person in the art may rearrange the steps to practice the present invention without departing from the spirit of the present invention. For example, the step associated with using a flag to enable or disable cross-tile boundary processing can be added to the flow chart. In another example, the step of modifying filter information determination to eliminate data dependency across tile boundaries may also be included in the flow chart.

The exemplary syntax design for SPS and PPS shown in FIG. 8 and FIG. 9 respectively illustrates a specific implementation to enable tile dependence control. A skilled person in the field may use other syntax element or rearrange control flow to achieve the practice described here without departing from the spirit of the present invention.

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

Embodiment of the present invention as described above may be implemented in various hardware, software codes, or a combination of both. For example, an embodiment of the present invention can be a circuit integrated into a video compression chip or program code integrated into video compression software to perform the processing described herein. An embodiment of the present invention may also be program code to be executed on a Digital Signal Processor (DSP) to perform the processing described herein. The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware code may be developed in different programming languages and different formats or styles. The software code may also be compiled for different target platforms. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A method for loop filter processing of video data, the method comprising:
receiving video data associated with a picture, wherein the picture is partitioned into one or more tiles;
determining tile boundaries associated with said one or more tiles;
determining whether cross-tile loop processing is disabled;
reconfiguring the loop filter processing if the cross-tile loop processing is disabled, wherein said reconfiguring the loop filter processing eliminates data dependency across at least one tile boundary of a current tile if the loop filter processing requires at least one pixel from a neighboring tile across said at least one tile boundary; and
applying the loop filter processing to said one or more tiles.

2. The method of claim 1, wherein said reconfiguring the loop filter processing corresponds to skipping the loop filter processing, replacing said at least one pixel from the neighboring tile across said at least one tile boundary using data padding based on the pixels of the current tile, or modifying data footprint or filter footprint to eliminate data dependency across said at least one tile boundary.

3. The method of claim 1, wherein the loop filter processing corresponds to DF (deblocking filter), SAO (Sample Adaptive Offset) processing or ALF (Adaptive Loop Filter) processing.

4. The method of claim 1, wherein the loop filter processing corresponds to DF, and wherein the loop filter processing is skipped for said at least one tile boundary.

5. The method of claim 1, wherein the loop filter processing corresponds to SAO, and wherein said reconfiguring the loop filter processing corresponds to skipping the loop filter processing for said at least one tile boundary, replacing said at least one pixel from the neighboring tile across said at least one tile boundary using data padding based on the pixels of the current tile, or modifying pixel classification footprint to eliminate data dependency across said at least one tile boundary.

6. The method of claim 5, wherein said data padding corresponds to repetitive padding, mirror padding with odd symmetry, mirror based padding with even symmetry, linear extrapolation or nonlinear extrapolation.

7. The method of claim 1, wherein the loop filter processing corresponds to ALF, and wherein said reconfiguring the loop filter processing corresponds to skipping the loop filter processing for said at least one tile boundary, replacing said at least one pixel from the neighboring tile across said at least one tile boundary using data padding based on the pixels of the current tile, or modifying filter footprint to eliminate data dependency across said at least one tile boundary.

8. The method of claim 7, wherein said data padding corresponds to repetitive padding, mirror padding with odd symmetry, mirror based padding with even symmetry, linear extrapolation or nonlinear extrapolation.

9. The method of claim 1, wherein said determining whether cross-tile loop processing is disabled is indicated by a flag, wherein the flag is coded at sequence, picture, or slice level to indicate whether data dependency across said at least one tile boundary is allowed.

10. The method of claim 9, wherein the flag is coded if said one or more tiles are more than one and otherwise the flag is not coded.

11. A method for loop filter processing of video data, the method comprising:
receiving video data associated with a picture, wherein the picture is partitioned into one or more tiles;
determining tile boundaries associated with said one or more tiles;
determining filter information for said one or more tiles, wherein said determining filter information is modified to eliminate first data dependency across at least one first tile boundary of a current tile if said determining filter information requires at least one pixel from a first neighboring tile across said at least one first tile boundary; and
applying the loop filter processing to said one or more tiles using the filter information, wherein the loop filter processing is reconfigured to eliminate second data dependency across at least one second tile boundary of the current tile if the loop filter processing requires at least one pixel from a second neighboring tile across said at least one second tile boundary.

12. The method of claim 11, wherein said reconfiguring the loop filter processing corresponds to skipping the loop filter processing, replacing said at least one pixel from the neighboring tile across said at least one tile boundary using data padding based on the pixels of the current tile, or modifying data footprint or filter footprint to eliminate data dependency across said at least one tile boundary.

13. The method of claim 11, wherein the loop filter processing corresponds to DF (deblocking filter), SAO (Sample Adaptive Offset) processing or ALF (Adaptive Loop Filter) processing.

14. The method of claim 13, wherein the loop filter processing corresponds to DF, and wherein the loop filter processing is skipped for said at least one second tile boundary.

15. The method of claim 13, wherein the loop filter processing corresponds to SAO, and wherein said reconfiguring the loop filter processing corresponds to skipping the loop filter processing for said at least one tile boundary, replacing said at least one pixel from the neighboring tile across said at least one second tile boundary using data padding based on the pixels of the current tile, or modifying pixel classification footprint to eliminate data dependency across said at least one tile boundary.

16. The method of claim 15, wherein said data padding corresponds to repetitive padding, mirror padding with odd symmetry, mirror based padding with even symmetry, linear extrapolation or nonlinear extrapolation.

17. The method of claim 13, wherein the loop filter processing corresponds to ALF, and wherein said reconfiguring the loop filter processing corresponds to skipping the loop filter processing for said at least one second tile boundary, replacing said at least one pixel from the neighboring tile across said at least one second tile boundary using data padding based on the pixels of the current tile, or modifying filter footprint to eliminate data dependency across said at least one second tile boundary.

18. The method of claim 17, wherein said data padding corresponds to repetitive padding, mirror padding with odd symmetry, mirror based padding with even symmetry, linear extrapolation or nonlinear extrapolation.

19. The method of claim 11, wherein a flag is coded at sequence, picture, or slice level to indicate whether data dependency across said at least one second tile boundary is allowed.

20. The method of claim 19, wherein the flag is coded if said one or more tiles are more than one and otherwise the flag is not coded.

21. An apparatus for loop filter processing of video data in a video decoder, the apparatus comprising:
means for receiving video data associated with a picture, wherein the picture is partitioned into one or more tiles;
means for determining tile boundaries associated with said one or more tiles;
means for determining whether cross-tile loop processing is disabled;
means for reconfiguring the loop filter processing if the cross-tile loop processing is disabled, wherein said means for reconfiguring the loop filter processing eliminates data dependency across at least one tile boundary of a current tile if the loop filter processing requires at least one pixel from a neighboring tile across said at least one tile boundary; and
means for applying the loop filter processing to said one or more tiles.

22. An apparatus for loop filter processing of video data, the apparatus comprising:
means for receiving video data associated with a picture, wherein the picture is partitioned into one or more tiles;
means for determining tile boundaries associated with said one or more tiles;
means for determining filter information for said one or more tiles, wherein said determining filter information is modified to eliminate first data dependency across at least one first tile boundary of a current tile if said determining filter information requires at least one pixel from a first neighboring tile across said at least one first tile boundary; and
means for applying the loop filter processing to said one or more tiles using the filter information, wherein the loop filter processing is reconfigured to eliminate second data dependency across at least one second tile boundary of the current tile if the loop filter processing requires at least one pixel from a second neighboring tile across said at least one second tile boundary.
